(19) United States
(12) Patent Application Publication
(10) Pub. No.: US 2012/0072932 A1
(43) Pub. Date: Mar. 22, 2012

(54) SYSTEM AND METHOD FOR CONTROLLING AND MANAGING THE DELIVERY OF DIGITAL MEDIA TO DEVICES ON HOME NETWORKS

(75) Inventors: Beauford W. Atwater, Bernardsville, NJ (US); Munir Cochinwala, Basking Ridge, NJ (US); Ashish Jain, Bridgewater, NJ (US)

(73) Assignee: TELCORDIA TECHNOLOGIES, INC., Piscataway, NJ (US)

(21) Appl. No.: 13/071,816

(22) Filed: Mar. 25, 2011

Related U.S. Application Data
(60) Provisional application No. 61/317,914, filed on Mar. 26, 2010.

(51) Int. Cl. H04N 21/462; H04N 21/2543

(52) U.S. Cl. 725/1; 725/39

(57) ABSTRACT

A system and method for controlling and managing delivery of digital media to devices on a home network is presented. The system comprises an application server executed by a physical or virtual CPU, the application server notified by each device when each device initializes, a plurality of plug-ins, each device corresponding to at least one plug-in, and a control plane, wherein the control plane receives notice of an event from one device and sends the notice of the event to the application server, which sends the notice of the event to the plug-in corresponding to the one device having the event, and the plug-in performs the event. The plug-in can perform the event by streaming content data to a desired device. The application server can maintain user information and when the plug-in performs the event, the plug-in updates the user information. The application server can have an interactive program guide.

### CROSS REFERENCE TO RELATED APPLICATIONS

The present invention claims the benefit of U.S. provisional patent application 61/317,914 filed Mar. 26, 2010, the entire contents and disclosure of which are incorporated herein by reference as if fully set forth herein.

### FIELD OF THE INVENTION

This invention relates generally to the delivery of digital media to devices on home networks.

### BACKGROUND OF THE INVENTION

A typical household has several network enabled devices such as PCs, Game Console Boxes, Cable Set-top boxes, DVRs, and TVs. Most of these devices rely on their manufacturer's pre-configured settings to access digital content, also called on-deck content, including digital media, and require an expert to re-configure these pre-configured settings. This limits the digital content the devices can access. To access off-deck content, that is, content which is not part of the device manufacturer's partnership or configuration, these devices need professional or advanced users to set them up, along with additional cables, hardware and/or software.

A sophisticated or expert user can establish her own home media network by installing media servers such as Windows Media Server or Google Media Center on her personal computer (PC) and configuring it to stream content to other devices. Any Universal Plug-n-Play (UPnP) device, such as some game consoles boxes, can discover such streams and play them on an appropriately enabled TV, given an advanced user or professional.

Additionally, many devices, such as XBOX, Wii Console Player, and internet-enabled TV, come with settings to connect to a portal for receiving digital content. Usually this portal is run by the manufacturer who controls the content that is made available, e.g., on-deck content.

A user-established home media network has several shortcomings. For example, it requires considerable expertise to run the additional cabling and properly implement the additional hardware and/or software. Further, there are Digital Rights Management (DRM) issues that limit the scope and extensibility of such networks. Quite often, a content owner may want to restrict how and where the streaming of his content can occur. The owner may not want to stream to a PC for fear of the user burning DVDs or doing peer-to-peer broadcasting. Also, business arrangements for on-deck content have been slow to evolve and thus limit consumers' choices.

Server-centric intelligent session management approaches are limited to traditional telephony services. Also, number dialing devices like telephones are more uniform and simpler than user devices in home networks, such as game consoles, DVRs, DVD players, wireless smart phone, etc.

In addition, home media network and access to on-deck content have very inflexible payment and settlement systems. Since the arrangements are mostly bilateral, such as either between the content provider and end user, or between the device maker and content provider, there are inherent extensibility issues as new devices are added or as new content providers emerge. Such bilateral on-deck agreements fail to provide access to “any content on any device” and do not offer a uniform access to any device to the content partners.

Device manufacturers have no incentive to reduce the number of devices in the home and service providers have little or no understanding of home networks. Hence there is a need for a technology that enables any content or service provider to legitimately sell their content to any user, irrespective of the type of home device(s) the user has.

### SUMMARY OF THE INVENTION

An inventive system and method to manage the session between user devices and content servers such that, irrespective of the home device type, user can easily navigate and access desired content is presented. This novel system can consist of an application server and several plug-ins. The application server can reside in a physical location or on a virtual machine or CPU supported by a cloud of physical machines or CPUs with an intervening hypervisor layer. The inventive approach makes it possible for ordinary users to access any authorized digital content from any source using any home device without the need for the user to install additional hardware and/or software in his or her home network.

The inventive system for controlling and managing the delivery of digital media to devices on a home network comprises an application server executed by a virtual or physical CPU or CPUs, the application server notified by each device on the home network when each device initializes, a plurality of plug-ins, each device corresponding to at least one plug-in, and a control plane, wherein the control plane receives notice of an event from one device and sends the notice of the event to the application server, the application server sends the notice of the event to the plug-in corresponding to the one device having the event, and the plug-in performs the event.

In one aspect, the plug-in performs the event by streaming content data to a desired device on the home network. In one aspect, the application server maintains user information and when the plug-in performs the event, the plug-in updates the user information. In one aspect, the application server provides a splash screen having an interactive program guide. In one aspect, the system further comprises a plug-in operable to manage an interactive program guide on the application server. In one aspect, the application server performs one or more of rating and charging, policy management, user profile management, digital rights management, and security management. In one aspect, the plug-in performs the event by selecting content format, downloading the content using the control plane onto a desired device on the home network, and providing information to update profile information and billing information on the application server. In one aspect, the plug-in is implemented using one of JEE, Microsoft.Net, and SPRING. In one aspect, the application server resides on a virtual machine or CPU supported by a cloud of physical machines or CPUs with an intervening hypervisor layer.

The inventive method for controlling and managing the delivery of digital media to devices on a home network comprises steps of notifying an application server executed by a CPU when each device on the home network initializes, corresponding each device to at least one plug-in, receiving, at a control plane, notice of an event on one device and sending the notice of the event to the application server, sending the notice of the event from the application server to the plug-in corresponding to the one device having the event, and performing the event.

In one aspect, the event is performed by streaming content data to a desired device on the home network. In one aspect, the application server maintains user information and when the event is performed, the user information is updated. In one aspect, the method further comprises managing an interactive program guide on the application server. In one aspect, the method further comprises performing one or more of rating and charging, policy management, user profile management, digital rights management, and security management. In one aspect, the step of performing the event comprises selecting a format for desired content, downloading the desired content onto a desired device on the home network, and providing information to update profile information and billing information on the application server.

A computer readable storage medium storing a program of instructions executable by a machine to perform one or more methods described herein also may be provided.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a schematic of one embodiment of the inventive system.

FIG. 2 is an exemplary splash screen of one embodiment of the inventive system.

FIG. 3 is a flow diagram of the inventive method.

### DETAILED DISCLOSURE

An inventive approach to delivering digital content to home networks is presented. Several content providers now provide internet streaming content through portals such as hulu.com and espn360.com. Users typically watch these on a computer or PC. The novel solution presented herein allows ordinary users to access and view these content sources on a device of their choice, such as their TV, without buying any additional equipment, hardware and/or software (they may still have to pay for the additional content).

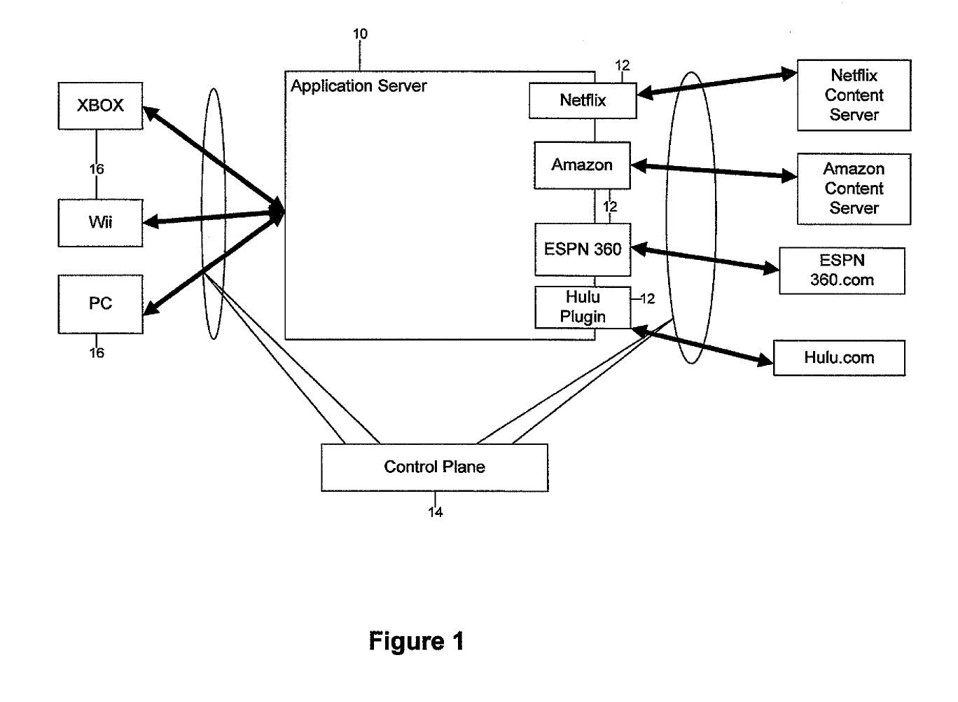

FIG. 1 is a schematic of an embodiment of the present invention. The inventive system shown in FIG. 1 consists of an application server 10 hosted inside a Network Data Center (not shown) or inside many Network Data Centers configured as a cloud (not shown) and a collection of plug-ins 12 that execute on this application server 10 and manage the requests for content. The application server 10 may optionally store a user profile, a user account and/or billing information. The application server 10 can be executed on a CPU (not shown).

The control plane or control plane architecture 14 performs all required set up between the user devices 16, the application server 10, the plug-ins 12 and content servers 18. The application server manages the control plane 14 for devices 16 in the home network. In the embodiment shown in FIG. 1, the devices 16 include an XBOX, a Wii, and a PC; however, any devices can be used. The devices 16 must first connect to the application server 10. Upon startup, devices discover the application server's IP address and connect to the “splash” screen of the application server. The splash screen for the application server is typically an interactive digital media search and programming guide application.

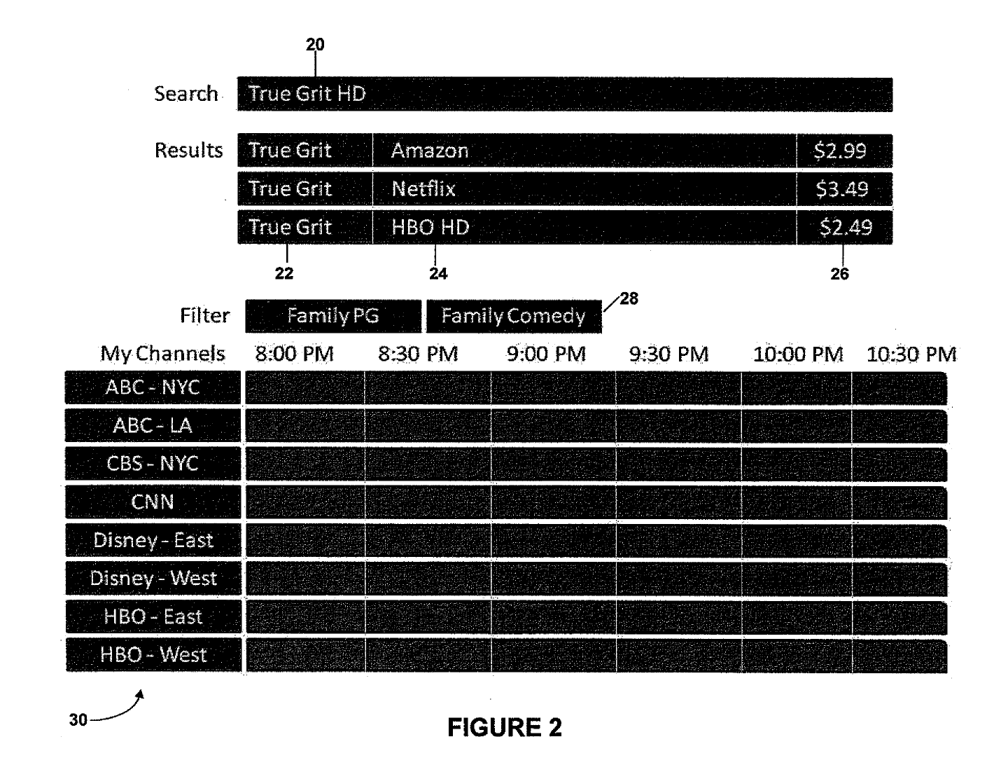

An exemplary splash screen is shown in FIG. 2. This splash screen includes a box or input area 20 into which a user can input search criteria. Search results are shown below the search in areas 22, 24, 26. Area 22 shows the name of the program, area 24 shows a source from which the program can be obtained and area 26 shows the cost of the program. Area 28 is a section in which a user can add additional search or filter criteria, such as program ratings, e.g., “Family PG”, and program type, e.g., “Family Comedy”. Area 30 is a television schedule including channels or networks including broadcast networks, cable networks, etc., and programs available on those channels at given times. For example, broadcast channels can include ABC-NYC, ABC-LA, CBS-NYC, CNN, etc. Schedule times can be in thirty-minute increments, such as 8:00 PM, 8:30 PM, etc. Other formats can be used.

The control plane 14, which can reside between user devices 16 and application server 10, can be implemented using a variety of approaches. In one embodiment, the control plane is implemented using generic triggers on user devices that can be armed to send a notification to the application server upon detection of conditions that satisfy the trigger. One embodiment uses an http browser-based control plane or layer where user events, such as search, selection, playback controls, e.g., play, rewind, forward, record, pause, and end of streaming events, are sent to the application server using http protocol. Performing an event may lead to other events or streaming of content to a desired device.

The application server 10 hosts third party plug-ins 12 which are software developed to be executed on the inventive application server. Upon detection by the control plane 14 of a user event, the control plane sends the event to the application server which hands over that event to the appropriate plug-in. For example, if the user has selected to stream or download content from Amazon.com, the application server will hand over the user device information (such as IP address and device type) and user profile information (such as account balances and age verification) to an Amazon plug-in on the server 10. The Amazon plug-in will have the appropriate logic to perform account balance updates, to select the appropriate content format for streaming or downloading, and to enable the streaming or downloading of the content using the control plane onto the desired user device. Plug-in component architecture can be implemented using one of several software component technologies such as JEE, Microsoft .Net, SPRING, etc.

Plug-ins are not limited to downloading or streaming of media. For example, developers could write plug-ins to manage the interactive program guides. Such plug-ins could allow access to other social networking sites by devices on the home network.

In addition to the basic functionality described above, the application server can provide several additional capabilities. These include, but are not limited to, extra functionality such as rating and charging, policy management, user profiles, security, etc. Rating and charging can be used to create marketing promotions where content providers can offer loyalty and usage based pricing, among other things.

If optionally configured, the application server can collect user statistics and information in a profile, and can use this information to dynamically adapt and personalize the interactive program guide. For example, the application server can use the collected information to filter the catalogs of content partners to display search results or programming guide contents which are more relevant to the user. These additional features can be accessed and/or implemented by plug-ins as well.

An example of the inventive system and method follows. In this example, a user has a home network that includes at least a Wii and a TV. The user wants to download a television show to watch, so he uses his Wii browser to connect to the search page on the TV screen. In another embodiment, the user connects to a search box that is part of an Interactive Program Guide, which is software running on the application server in the Network Data Center. The user opens the search window on the splash screen or search page of the TV and searches for the specific television show that he wants to see.

In this example, the search function is provided by a plug-in on the application server. After the user indicates the television show to search for, the application server plug-in searches multiple video repositories based on the user's profile, e.g., user statistics and information collected by the application server. These video repositories can include broadcast television networks, Amazon.com, and others. Results are displayed from the various video repositories. After the user selects a show from one video repository, in this example from Amazon.com, the application server hands over the control to the selected repository's, e.g., Amazon's, plug-in. The plug-in instructs the Amazon content server to start streaming content to the user's home network via the Wii console (Wii's IP address is provided to the server). The show streams to the TV in the user's home network and payment is made to Amazon.

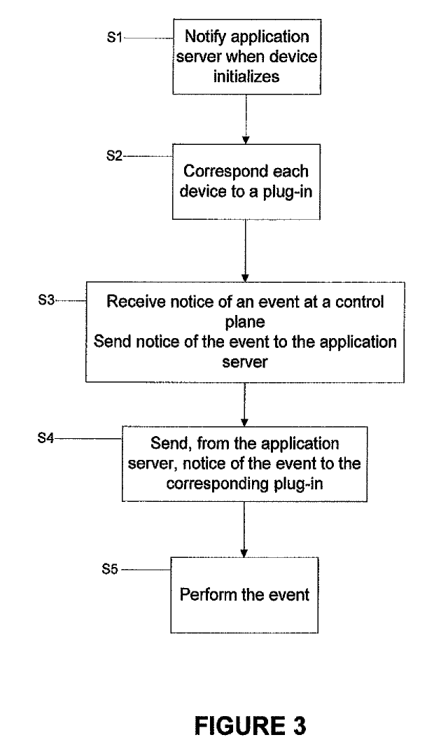

FIG. 3 is a flow diagram of the inventive method. In step S1, the application server is notified when a device on the home network is initialized. In step S2, each device on the home network is corresponded to at least one plug-in. Typically, step S2 is performed only for the device that was initialized in step S1. In step S3, notice is received at the control plane that an event has occurred on a device on the home network, and this notice is sent by the control plane to the application server. In step S4, the application server sends the notice of the event to the corresponding plug-in. In step S5, the corresponding plug-in performs the event. This performance may include one or more of streaming content data to the desired device on the home network, maintaining and updating user information on the application server, managing policies, managing security, updating rating and charging information, etc. Performing the event may also include selecting a format for the desired content, downloading the desired content onto a desired device on the home network, and providing information to update profile information and billing information on the application server.

The system and method presented herein uses control planes or control plane architecture in a novel way. To date, control planes have been only used to manage transport networks, and content distribution has not been thought of as a control plane problem. In the present invention, control plan architecture enables communication between a device and an application server in a Network Data Center. In addition, the invention manages home network devices in a novel fashion; currently, home network management manages only the local area network aspects of the home.

The invention provides many advantages. For example, users control the content on their network. They can create policies that allow certain types of content onto their network, and can control which device receives content. For example, movies can go to the television. YouTube videos can go to the PC. Text messages can go to the mobile phone or the television. Games go to the game console.

Beneficially, users have control over where their content comes from. For example, when users want to download television programs they can search the entire Internet for the programs rather than just the video on demand repository of their service provider. For instance, users can go to Amazon and purchase content and stream it to whichever device they want.

Further benefits include providing users with control over device configuration. For example, users can program parental controls globally for the home network rather than each individual device. Users can program firewall controls globally for the home network. Content and device providers do not need pairwise agreements for delivering specific content over a specific device. A content provider can now have users view their content over any device in the user's environment.

Additional advantages to the invention include that it does not require user programming or the user buying additional equipment, it provides devices certification and DRM policy enforcement on behalf of content owners, irrespective of what device the content streams on, and it offers the ability to personalize and offer more targeted content choices to users.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc. The system also may be implemented on a virtual computer system, colloquially known as a cloud.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server, and network of servers (cloud). A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A system for controlling and managing delivery of digital media to devices on a home network, comprising:
an application server executed by a CPU, the application server notified by each device on the home network when each device initializes;
a plurality of plug-ins, each device corresponding to at least one plug-in; and
a control plane, wherein
the control plane receives notice of an event from one device and sends the notice of the event to the application server, the application server sends the notice of the event to the plug-in corresponding to the one device having the event, and the plug-in performs the event.

2. The system according to claim 1, wherein the plug-in performs the event by streaming content data to a desired device on the home network.

3. The system according to claim 1, wherein the application server maintains user information and when the plug-in performs the event, the plug-in updates the user information.

4. The system according to claim 1, wherein the application server provides a splash screen having an interactive program guide.

5. The system according to claim 4, further comprising a plug-in operable to manage the interactive program guide on the application server.

6. The system according to claim 1, wherein the application server performs one or more of rating and charging, policy management, user profile management, digital rights management, and security management.

7. The system according to claim 1, wherein the plug-in performs the event by selecting format of a content, downloading the content using the control plane onto a desired device on the home network, and providing information to update profile information and billing information on the application server.

8. The system according to claim 1, wherein the application server resides on a virtual machine or CPU supported by a cloud of physical machines or CPUs with an intervening hypervisor layer.

9. A method for controlling and managing delivery of digital media to devices on a home network, comprising steps of:
notifying an application server executed by a CPU when each device on the home network initializes;
corresponding each device to at least one plug-in;
receiving, at a control plane, notice of an event on one device and sending the notice of the event to the application server;
sending the notice of the event from the application server to the plug-in corresponding to the one device having the event; and
performing the event.

10. The method according to claim 9, wherein the event is performed by streaming content data to a desired device on the home network

11. The method according to claim 9, wherein the application server maintains user information and when the event is performed, the user information is updated.

12. The method according to claim 9, further comprising the step of managing an interactive program guide on the application server.

13. The method according to claim 9, further comprises the step of performing one or more of rating and charging, policy management, user profile management, digital rights management, and security management.

14. The method according to claim 9, wherein the step of performing the event comprises steps of:
selecting a format for desired content;
downloading the desired content onto a desired device on the home network; and
providing information to update profile information and billing information on the application server.

15. A computer readable storage medium storing a program of instructions executable by a machine to perform a method for controlling and managing delivery of digital media to devices on home networks, comprising steps of:
notifying an application server executed by a CPU when each device on the home network initializes;
corresponding each device to at least one plug-in;
receiving, at a control plane, notice of an event on one device and sending the notice of the event to the application server;
sending the notice of the event from the application server to the plug-in corresponding to the one device having the event; and
performing the event.

16. The computer readable medium according to claim 15, wherein the event is performed by streaming content data to a desired device on the home network

17. The computer readable medium according to claim 15, wherein the application server maintains user information and when the event is performed, the user information is updated.

18. The computer readable medium according to claim 15, further comprising the step of managing an interactive program guide on the application server.

19. The computer readable medium according to claim 15, further comprises the step of performing one or more of rating and charging, policy management, user profile management, digital rights management, and security management.

20. The computer readable medium according to claim 15, wherein the step of performing the event comprises steps of
selecting a format for desired content;
downloading the desired content onto a desired device on the home network; and
providing information to update profile information and billing information on the application server.
